(19) United States
(12) Patent Application Publication
(10) Pub. No.: US 2025/0389867 A1
(43) Pub. Date: Dec. 25, 2025

(54) METHODS FOR DESIGNING METALENS AND SYSTEMS THEREOF

(71) Applicant: Hong Kong Applied Science and Technology Research Institute Company Limited, Hong Kong (CN)

(72) Inventors: Peng XIE, Hong Kong (CN); Qingyi YANG, Hong Kong (CN); Ruiting SUN, Hong Kong (CN); Yunhe LAI, Hong Kong (CN); Ying Suet LAU, Hong Kong (CN); Ka Yiu WONG, Hong Kong (CN); Tak Shing AU YEUNG, Hong Kong (CN)

(21) Appl. No.: 18/752,837

(22) Filed: Jun. 25, 2024

(51) Int. Cl. G02B 1/00; B82Y 20/00

(52) U.S. Cl. CPC G02B 1/002; B82Y 20/00; G02B 2207/101

(57) ABSTRACT

Embodiments are directed towards a method for designing a metalens, comprising selecting a group of metacells from a library at least based on their corresponding phase responses; receiving a description of incident optical signals and target optical signals; defining a phase rounding threshold value and a maximum number of rounding operations, wherein the phase rounding threshold value varies in terms of a rounding operation number; generating a phase for each metacell of the metalens with IFTA at least based on the description of the incident optical signals and the target optical signals; determining if the generated phase for each metacell meets the phase rounding threshold value, and if the phase rounding threshold value is met, performing a rounding operation by rounding the generated phase to the phase of one of the metacells from the selected group; and outputting the generated phases of all metacells when all rounding operations are completed.

### FIELD OF INVENTION

The present disclosure relates to design of optical systems, and more particularly, but not exclusively, to a method for designing a metalens and a system thereof.

### BACKGROUND OF INVENTION

Metalenses, two dimensional arrays of submicron metacells, have drawn growing research interest in recent years. They can offer low-cost, high-performance miniaturized optical systems, and utilize the advantage of nanofabrication as well as computational tools. To achieve the desired optical effect, simulation needs to be done to assess system performance prior to fabrication of metalenses.

### SUMMARY OF INVENTION

Briefly stated, embodiments are directed towards a method for designing a metalens, comprising selecting a group of metacells from a library at least based on their corresponding phase responses; receiving a description of incident optical signals and target optical signals; defining a phase rounding threshold value and a maximum number of rounding operations, wherein the phase rounding threshold value varies in terms of a rounding operation number; generating a phase for each metacell of the metalens with IFTA at least based on the description of the incident optical signals and the target optical signals; determining if the generated phase for each metacell meets the phase rounding threshold value, and if the phase rounding threshold value is met, performing a rounding operation by rounding the generated phase to the phase of one of the metacells from the selected group; and outputting the generated phases of all metacells when all rounding operations are completed.

Specifically, the method further comprises the step of: when at least one of the generated phases does not meet the phase rounding threshold value, continuing to generate a phase for each metacell with IFTA at least based on result of prior rounding operation.

Specifically, the selected group includes N metacells, and the phases of the N metacells constitutes a set identified as [a₁ . . . a_{N}], wherein N is an integer no less than 2; wherein defining a phase rounding threshold value and a maximum number of rounding operation includes, extending the set to [a₀ . . . a_{N+1}], wherein a₀=a_{N}−2π, a_{N+1}=a₁+2π.

Specifically, defining a phase rounding threshold value and a maximum number of rounding includes, defining mid-points [b₁ . . . b_{N+1}] between adjacent points in [a₀ . . . a_{N+1}], and defining phase difference [g₁ . . . g_{N+1}] between adjacent points in [a₀ . . . a_{N+1]}.

Specifically, defining a phase rounding threshold value and a maximum number of rounding operation includes defining the rounding operation number as integer p, and 1≤φ≤N_{sq}, wherein the phase rounding threshold value is defined as

$${\{ {ε}_{p} \}}_{p = 1}^{{N}_{sp}}$$

which varies between 0 and 1, wherein when p=1, the first phase rounding threshold value ε₁ is predetermined and 0<ε₁<½; defining the maximum number of rounding operations as N_{sq} to be

$$ceil [ \frac{ln {ε}_{1}}{ln ( 1 - {ε}_{1} )} ] ;$$

and defining the phase rounding threshold value as εₚ as

$$\{ \begin{matrix}1 - {( 1 - {ε}_{1} )}^{2} , p = 2 , \\ 1 - {( 1 - {ε}_{2} )}^{p - 1} , 2 < p < {N}_{sq} \\ 1 , p = {N}_{sq}\end{matrix} .$$

rounding φ to aⱼ, and maintaining the generated φ unchanged otherwise.

Specifically, generating a phase for each metacell of the metalens with IFTA at least based on the description of the incident optical signals and the target optical signals includes when the generated phase φ satisfies b₁≤φ≤b_{N+1}, specifically bⱼ<φ≤bⱼ₊₁, 1≤j≤N, when

$$- \frac{1}{2} {ε}_{p} * {g}_{j} < φ - {a}_{j} \leq \frac{1}{2} {ε}_{p} * {g}_{j + 1} ,$$

rounding φ to aⱼ, and maintaining the generated φ unchanged otherwise.

Specifically, generating a phase for each metacell of the metalens with IFTA at least based on the description of the incident optical signals and the target optical signals includes when the generated phase φ satisfies φ≤b₁, translating φ to φ′=φ+2π and when

$${φ}^{′} - {a}_{N} \leq \frac{1}{2} {ε}_{p} * {g}_{N + 1} ,$$

rounding φ to a_{N} and maintaining φ unchanged otherwise.

Specifically, generating a phase for each metacell of the metalens with IFTA at least based on the description of the incident optical signals and the target optical signals includes when the generated phase satisfies φ>b_{N+1}, translating φ to φ″=φ−2π and when

$${φ}^{″} - {a}_{1} > - \frac{1}{2} {ε}_{p} * {g}_{1} ,$$

rounding φ to a₁ and maintaining φ unchanged otherwise.

Specifically, the method further comprising the step of generating a layout information of metacells with a GPU based on at least the outputted phases of all metacells of the metalens.

The present disclosure further provides a metalens design system, comprising a processor and a memory communicatively coupled to the processor, wherein the processor is configured to perform any one of the aforementioned methods.

The present disclosure further provides a non-transitory computer readable medium storing instructions for designing a metalens that when executed by a processor causes the processor to perform any one of the aforementioned methods.

### BRIEF DESCRIPTION OF FIGURES

Non-limiting and non-exhaustive embodiments are described with reference to the following drawings. In the drawings, like reference numerals refer to like parts throughout the various figures unless otherwise specified.

For a better understanding of the present disclosure, reference will be made to the following Detailed Description, which is to be read in association with the accompanying drawings:

FIG. 1 illustrates an example of a metacell;

FIG. 2a is a diagram illustrating phase distribution with respect to height and width of metacells;

FIG. 2b is a diagram illustrating phase distribution with respect to width of metacells and with the height of 0.56 μm;

FIG. 3a is a diagram illustrating transmission rate distribution with respect to height and width of metacells;

FIG. 3b is a diagram illustrating transmission rate distribution with respect to width of metacells and with the height of 0.56 μm;

FIG. 4 illustrates phase and transmission properties of a group of selected metacells in accordance with one embodiment of the present disclosure;

FIG. 5a illustrates an image representation of input optical signal in accordance with one embodiment of the present disclosure;

FIG. 5b illustrates an image representation of target optical signal in accordance with one embodiment of the present disclosure;

FIG. 6 illustrates a flow diagram of phase quantization method in accordance with one embodiment of the present disclosure;

FIG. 7 illustrates phases of selected metacells distributed along an axis in accordance with one embodiment of the present disclosure;

FIG. 8 illustrates a quantized phase map established with phases of the selected metacells in accordance with one embodiment of the present disclosure; and

FIG. 9 illustrates top view of the GDS file of a metalens established with the selected metacells in accordance with one embodiment of the present disclosure.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks and the automobile environment, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the present disclosure. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

To increase the efficiency and accuracy of simulation tools of metalens, the present disclosure provides a method for metalens designing which specifically includes a method for phase map quantization of a metalens. Specifically, the present disclosure integrates a comprehensive workflow of metalens design, comprising the metacell phase response simulation, quantized phase retrieval, and the metacell distribution on the metalens array. The one-to-one correspondence between phase and metacell will also perfectly define the metacell dimension in the distribution on metalens surface.

A metalens employs pattern of metacells on a dielectric surface to manipulate incident optical signals. Specifically, the metacells pattern (shapes, sizes, and positions of the metacells across the metalens) can be designed to modify the phase profile of the incident optical signals, in order to achieve the desired optical signals. Compared to traditional lenses, metalenses are capable of providing a wider range of optical functionalities such as phase modification.

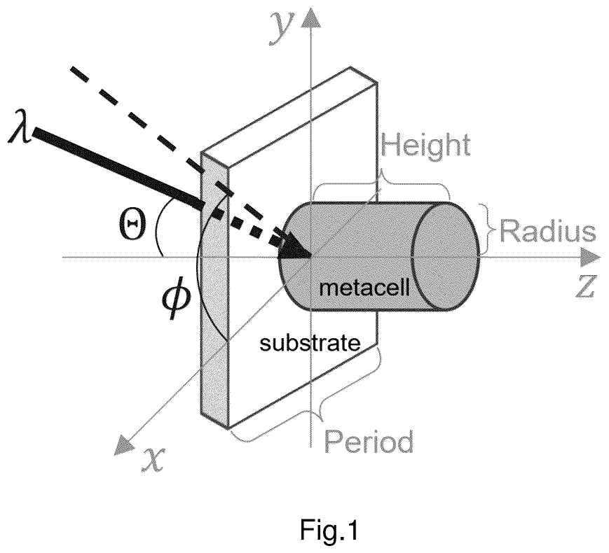

FIG. 1 illustrates an example of a metacell. When establishing phase and transmission library of metacells, a series of data needs to be collected. As shown in the figure, a metacell may stand on its corresponding substrate and the dimension of which would be called ‘period’ of the metacell. The ‘period’ may also be the physical distance between adjacent metacells.

The library may include models of different metacells. For example, a metacell may appear as a cylinder-shaped structure. To establish a model of a metacell, the diameter, height and material dielectric constant information of the metacell needs to be collected. Different metacells may correspond to different optical phase response abilities (hereinafter phases). Therefore, when performing simulation of metalenses, models of different metacells may be utilized to generate desired overall optical phase or phase response. For example, the phase response described by Maxwell equation may be computed by RCWA (Rigorous Coupled Wave Analysis) scheme.

The library may also include models of different optical signals. To establish models of optical signals, incident angles and wavelengths of incident optical signal may also be collected for model establishing purpose.

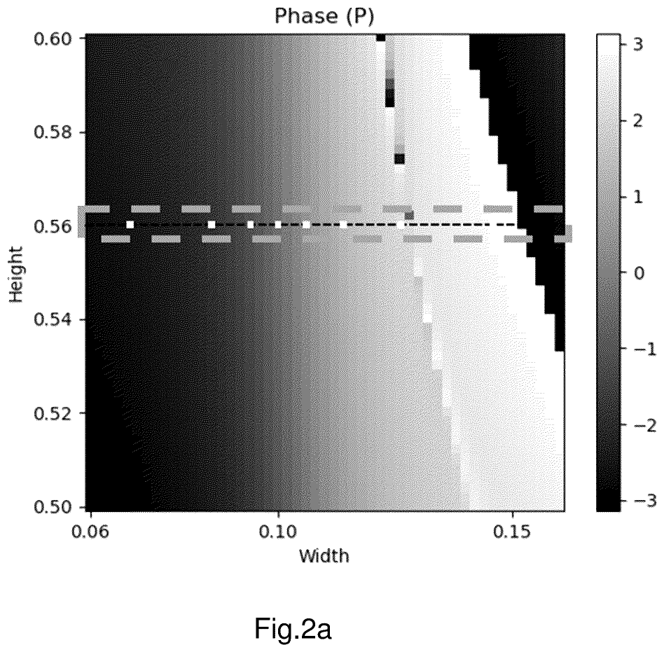

FIG. 2a is a diagram illustrating phase distribution with respect to height and width of metacells; FIG. 2b is a diagram illustrating phase distribution with respect to width of metacells when the height of the metacells is fixed at 0.56 μm. Phase distribution varies from −π to π in both diagrams.

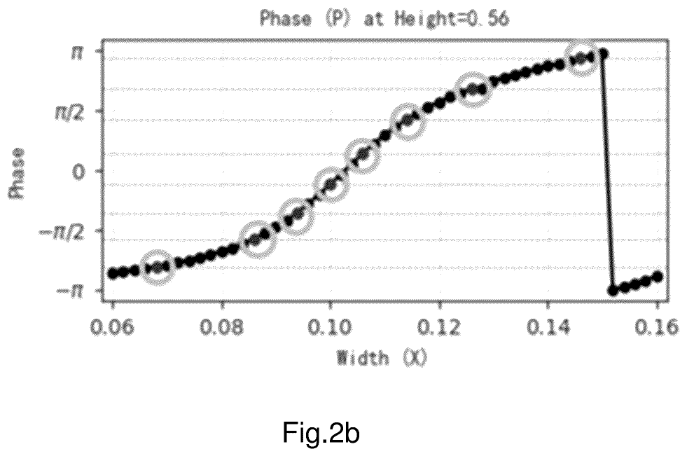

FIG. 3a is a diagram illustrating transmission rate distribution with respect to height and width of metacells; FIG. 3b is a diagram illustrating transmission rate distribution with respect to width of metacells when the height of the metacells is fixed at 0.56 μm.

In one embodiment, a group of metacells may be selected to form a metalens which can achieve desired optical function. In one embodiment, the group may be selected automatically according to a pre-determined standard, for example metacells with relatively high transmission rate, etc. Users may adjust the standard according to their needs.

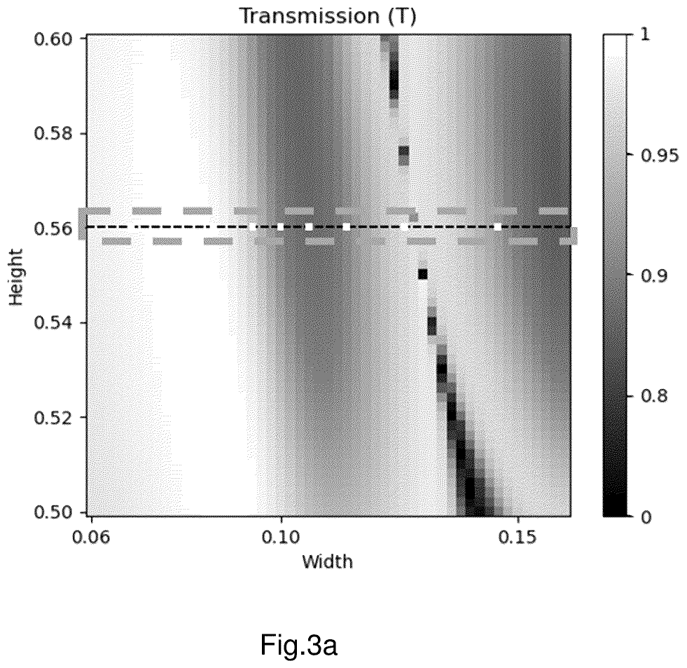

FIG. 4 illustrates properties of a group of selected metacells in accordance with one embodiment of the present disclosure. In one embodiment, as shown in FIGS. 2a-FIG. 4, the group of selected metacells may have the same height, for example 0.56 μm; the chosen metacells may have relatively high transmission rate, for example approaching or even slightly exceeding 90%; also, the phases of the selected group of metacells may vary in the range of −π to π approximately uniformly. In one embodiment, on one hand, the phase difference between selected metacells may not necessarily be the same under the circumstance of simulation and fabrication, on the other hand, it should be selected closely to each other in the phase group selection.

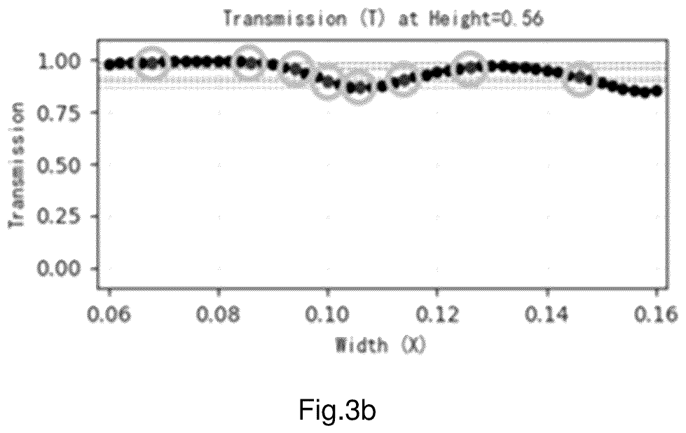

FIG. 5a illustrates an image representation of input optical signal in accordance with one embodiment of the present disclosure, which may be represented by u₀; FIG. 5b illustrates an image representation of the target optical signal in accordance with one embodiment of the present disclosure, which may be represented by U₀.

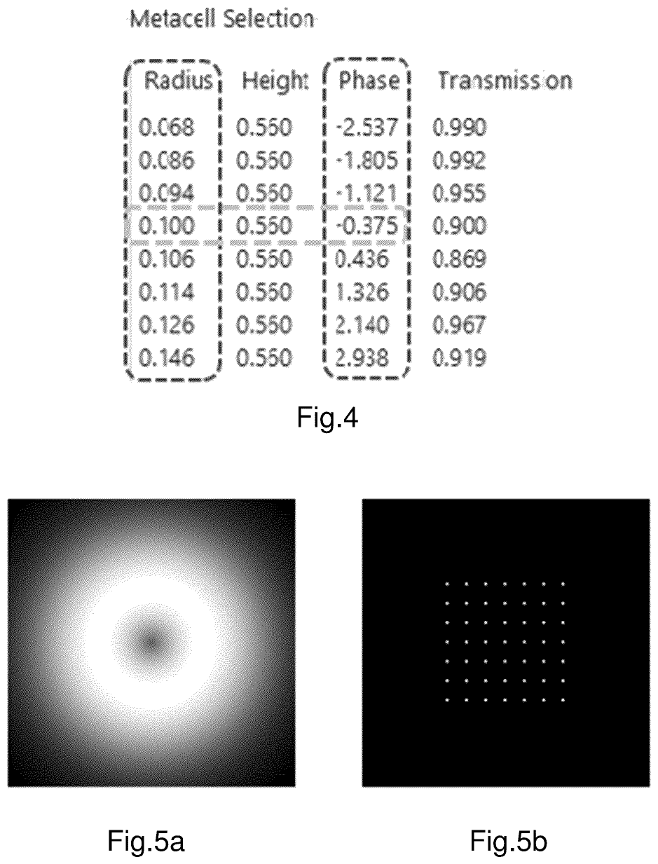

FIG. 6 illustrates a flow diagram of phase quantization method in accordance with one embodiment of the present disclosure.

To design a metalens, an array of metacells is to be established in order to achieve the target optical signal, wherein each or most of the metacells may have a different phase response to the input optical signal. Such phase response difference may result in a great number of different types of metacells, which may cause difficulty in fabrication. To increase the fabrication efficiency, phase quantization of metacells is adopted to limit the phases of metacells to a fixed number, and therefore only a pre-determined types of metacells are used to form the metalens.

In recent phase quantization approaches, it is usually performed in a direct way, wherein the phase of each metacell in the array are rounded to the phase of a selected metacell according to a fixed and static standard. Such method which is called hard quantization may impair the final optical effect and may not achieve the desired target optical signal, though computational and fabrication resource consumption may be reduced compared to those without quantization.

At 602, selecting a group of metacells at least based on their corresponding phase responses.

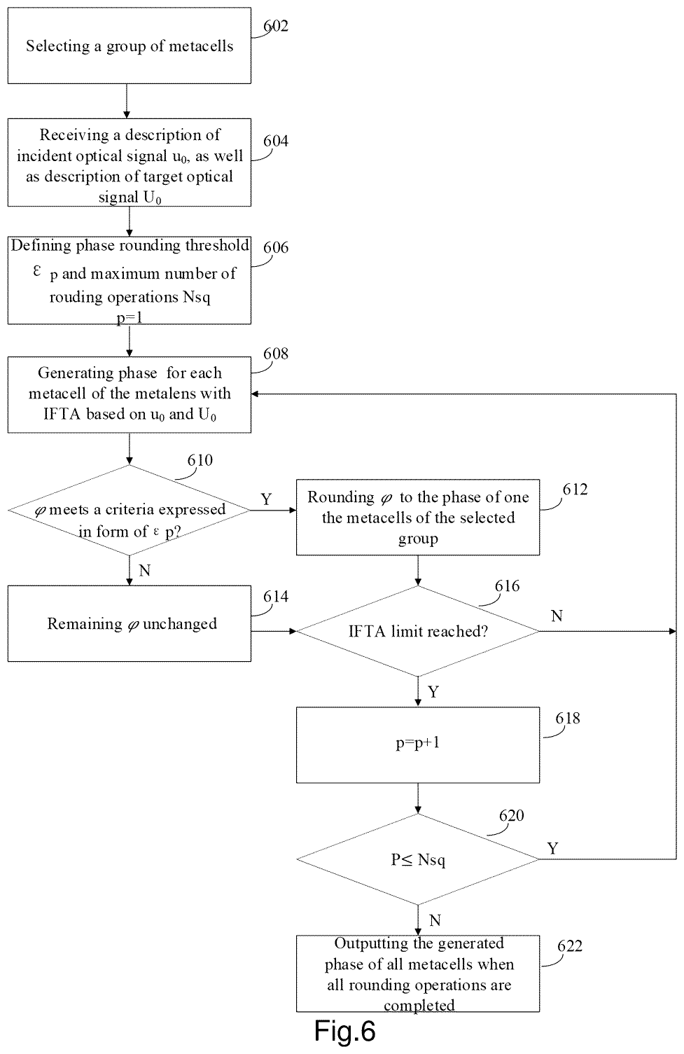

Now referring to FIG. 7, which illustrates phases of selected metacells distributed along an axis in accordance with one embodiment of the present disclosure.

Specifically, points [a₁ . . . a_{N}] represents phases of N selected metacells varying within −π to π, wherein N is an integer no smaller than 2, for example N is 8 in the embodiment as shown in FIG. 7.

In one embodiment, sizes of the metacells in the selected group should be distinguishable, for example at least ±5% difference in between.

In one embodiment, the group may be selected automatically according to a pre-determined standard.

Now referring back to FIG. 6. At 604, receiving description of incident optical signal u₀, as well as description of target optical signal U₀. FIG. 5a and FIG. 5b illustrate an exemplary image representation of u₀ and U₀ in accordance to one embodiment of the present disclosure.

At 606, defining a phase rounding threshold value and a maximum number of rounding operations for phase quantization, and setting an initial value of p, which is the number of rounding operations, to 1.

In one embodiment, considering boundary conditions, two extra points a₀ and a_{N+1} are defined, wherein a₀=a_{N}−2π<−π and a_{N+1}=a₁+2π>π. For example, when N is 8, a₀ and a₉ are defined as shown in FIG. 7.

In one embodiment, mid-points [b₁ . . . b_{N+1}] between adjacent points of [a₀ . . . a_{N+1}] and phase difference [g₁ . . . g_{N+1}] between adjacent points of [a₀ . . . a_{N+1}] are defined for quantization purpose.

$${b}_{i} = \frac{{a}_{i} + {a}_{i - 1}}{2} ,$$

wherein i is an integer and i=1 . . . N+1

$${g}_{i} = {a}_{i} - {a}_{i - 1}$$

In one embodiment, in order to establish the metalens with the selected metacells, the phase of each metacell of the metalens needs to be rounded to the phase of one of the metacells from the selected group. In one embodiment, the number of rounding operations is defined as integer φ and 1≤p≤N_{sq}. Also, a series of phase rounding threshold values is defined as

$${\{ {ε}_{p} \}}_{p = 1}^{{N}_{sp}} ,$$

which monotonically increases between 0 and 1, wherein ε₁ is a predetermined value and 0<ε₁<½.

$${N}_{sq} = ceil [ \frac{ln {ε}_{1}}{ln ( 1 - {ε}_{1} )} ] , \qquad ( 1 )$$

$${ε}_{p} = \{ \begin{matrix}1 - {( 1 - {ε}_{1} )}^{2} , p = 2 , \\ 1 - {( 1 - {ε}_{2} )}^{p - 1} , 2 < p < {N}_{sq} \\ 1 , p = {N}_{sq}\end{matrix} , \qquad ( 2 )$$

wherein ceil[ ] represents the ceiling function.

At 608, generating phase φ for each metacell of the metalens with IFTA (iterative Fourier Transform Algorithm) based on u₀ and U₀. In various embodiments, one or more types of IFTA algorithms may be used at this stage to generate the phase p for each metacell. For example, a rough IFTA may be performed first and then a finer or proposed IFTA may be performed based on results from the rough one. In one embodiment, a simulated output image representation may be displayed to users each time after the IFTA is performed.

At 610, determining if φ meets the phase rounding threshold value εₚ, directing the flow to 612 if the two meets and directing the flow to 614 otherwise.

At 612, rounding the phase φ to the phase of one of the selected metacells. In one embodiment, a simulated output image representation may be displayed to users each time after the rounding is performed.

At 614, maintaining the phase φ.

In one embodiment, when b₁<φ≤b_{N+1}, specifically bⱼ<φ≤bⱼ₊₁, j is an integer and 1≤j≤N, at 610 determining if

$$- \frac{1}{2} {ε}_{p} * {g}_{j} < φ - {a}_{j} \leq \frac{1}{2} {ε}_{p} * {g}_{j + 1} ,$$

directing the flow to 612 and rounding φ to aⱼ if the criteria is met, and directing the flow to 614 if φ does not meet the criteria.

In another embodiment, when φ≤b₁, at 610 translating φ to φ′=φ+2π and determining if

$${φ}^{′} - {a}_{N} \leq \frac{1}{2} {ε}_{p} * {g}_{N + 1} ,$$

directing the flow to 612 and rounding φ to a_{N} if the criteria is met, and directing the flow to 614 if φ does not meet the criteria.

In yet another embodiment, when φ>b_{N+1}, at 610 translating φ to φ″=φ−2π and determining if

$${φ}^{″} - {a}_{N} > - \frac{1}{2} {ε}_{p} * {g}_{1} ,$$

directing the flow to 612 and rounding φ to a₁ if φ meets the criteria, and directing the flow to 614 if φ does not meet the criteria.

At 616, determining if the IFTA iteration number limit is reached, directing the flow to 618 if the limit is reached, and directing the flow to 608 if the limit is not reached. In one embodiment, the user may define the limit in various situations.

At 618, setting the number of rounding operation p to p+1, or incrementing p by 1.

At 620, determining if p≤N_{sq}, directing the flow back to 608 to continue IFTA when the criteria is met, and directing the flow to 622 when the criteria is not met.

In one embodiment, when the flow is directed back to stage 608, the IFTA algorithm used may be completely or partially the same as or completely different from the one used when generating the initial phases of the metacells based on u₀ and U₀, depending on user's arrangement.

In one embodiment, at this stage, phases of some metacells may have been rounded to those of selected metacells, and the following IFTA may be performed based on such rounding results and may generate a whole new set of phases for all metacells of the metalens.

At 622, outputting the phase for each metacell resulted from all the rounding operations. Specifically, the outputted phases of all metacells of the metalens are already rounded to the phases of selected metacells and the quantization is completed.

In one embodiment, the IFTA involves the large scaled matrix computation so that GPU acceleration would help to save the consuming time. The layout information of metalens or metasurface could be generated in the form of GDS or GDS II files based on the phase map retrieved in above embodiments.

In one embodiment, the metalens designed with the method in embodiments of the present disclosure may be used together with traditional optical lenses to establish an optical system.

In various embodiments, FIG. 6 is simply an example of a phase quantization method, of which the ordering of the operations may not be necessarily the same as FIG. 6, and may be adjusted according to actual situation without extending beyond the scope of the present disclosure.

In one embodiment of the present disclosure, a metalens design system may include a processor and a memory communicatively coupled to the processor, and the processor is configured to perform at least the method as illustrated in FIG. 6 and the related description. In one embodiment, the system may further include a display which may be configured to show the simulation result for example the simulated image representation after each rounding operation or each time after running the IFTA algorithm.

In one embodiment, disclosed herein is a non-transitory computer readable medium storing instructions for designing a metalens that when executed by a processor cause the processor to perform at least the method as illustrated in FIG. 6 and the related description.

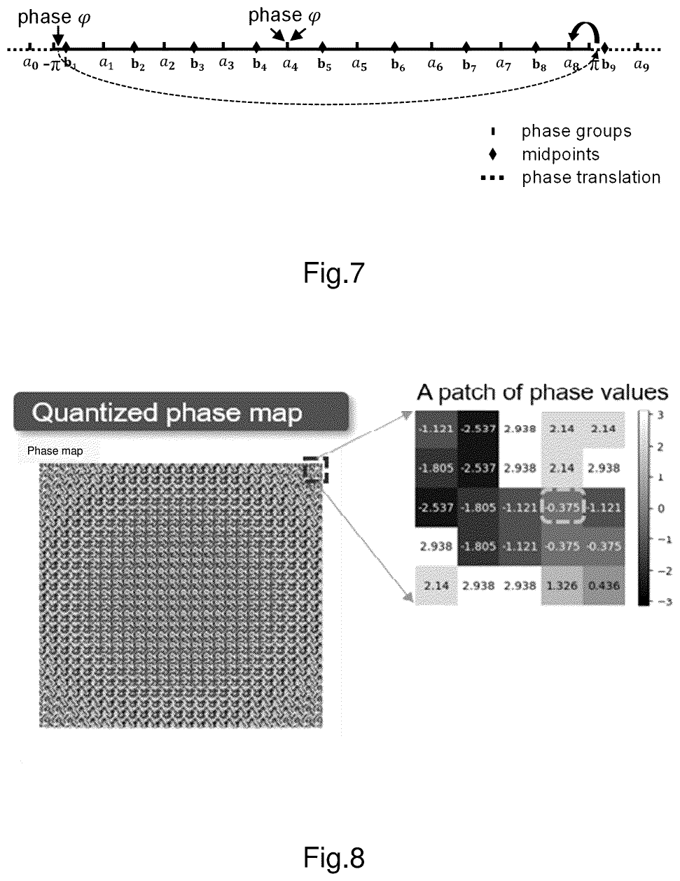

FIG. 8 illustrates a quantized phase map in the form of phases of the selected metacells in accordance with one embodiment of the present disclosure. Each of the phases identified in the patch are rounded to the phases of the selected metacells listed in FIG. 4.

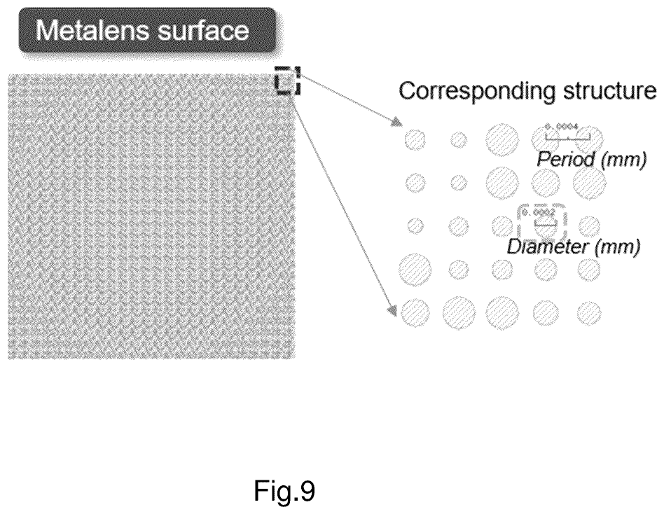

FIG. 9 illustrates a top view of the GDS file of a metalens surface established with the selected metacells in accordance with one embodiment of the present disclosure.

The method for metalens designing recited herein includes a soft quantization method to be performed according to a dynamic standard, which not only offers an approach to reduce computation and fabrication resource consumption, but also guarantees the desired accuracy of the metalens design tool and consequently of the metalens optical system.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

### Numbered Embodiments

Embodiment 1. A method for designing a metalens, comprising selecting a group of metacells from a library at least based on their corresponding phase responses;
receiving a description of incident optical signals and target optical signals;
defining a phase rounding threshold value and a maximum number of rounding operations, wherein the phase rounding threshold value varies in terms of a rounding operation number;
generating a phase for each metacell of the metalens with IFTA at least based on the description of the incident optical signals and the target optical signals;
determining if the generated phase for each metacell meets the phase rounding threshold value, and if the phase rounding threshold value is met, performing a rounding operation by rounding the generated phase to the phase of one of the metacells from the selected group; and
outputting the generated phases of all metacells when all rounding operations are completed.

Embodiment 2. The method of embodiment 1, further comprising the step of:
if at least one of the generated phases does not meet the phase rounding threshold value, continuing to generate a phase for each metacell with IFTA at least based on the result of the prior rounding operation.

Embodiment 3. The method of embodiment 1, wherein the selected group includes N metacells, and the phases of the N metacells constitute a set identified as [a₁ . . . a_{N}], wherein N is an integer no less than 2; wherein defining a phase rounding threshold value and a maximum number of rounding operation includes extending the set to [a₀ . . . a_{N+1}], wherein a₀=a_{N}−2π, a_{N+1}=a₁+2π.

Embodiment 4. The method of embodiment 3, wherein defining a phase rounding threshold value and a maximum number of rounding includes defining mid-points [b₁ . . . b_{N+1}] between adjacent points in [a₀ . . . a_{N+1}], and defining phase difference [g₁ . . . g_{N+1}] between adjacent points in [a₀ . . . a_{N+1]}.

Embodiment 5. The method of embodiment 4, wherein defining a phase rounding threshold value and a maximum number of rounding operation includes
defining the rounding operation number as integer p, and 1≤φ≤N_{sq}, wherein the phase rounding threshold value series is defined as

$${\{ {ε}_{p} \}}_{p = 1}^{{N}_{sp}}$$

which varies between 0 and 1, wherein when p=1, the first phase rounding threshold value ε₁ is predetermined and 0<ε₁<½;
defining the maximum number of rounding operations as N_{sq} to be

$$ceil [ \frac{ln {ε}_{1}}{ln ( 1 - {ε}_{1} )} ] ;$$

and
defining the phase rounding threshold value as εₚ to be

$$\{ \begin{matrix}1 - {( 1 - {ε}_{1} )}^{2} , & p = 2 , \\ 1 - {( 1 - {ε}_{2} )}^{p - 1} , & 2 < p < {N}_{sq} \\ 1 , & p = {N}_{sq}\end{matrix} .$$

Embodiment 6. The method of embodiment 5, wherein generating a phase for each metacell of the metalens with IFTA at least based on the description of the incident optical signals and the target optical signals includes
when the generated phase φ satisfies b₁<φ≤b_{N+1}, specifically bⱼ≤φ≤bⱼ₊₁, 1≤j≤N, when

$$- \frac{1}{2} {ε}_{p} * {g}_{j} < φ - {a}_{j} \leq \frac{1}{2} {ε}_{p} * {g}_{j + 1} ,$$

rounding φ to aⱼ, and maintaining the generated φ unchanged otherwise.

Embodiment 7. The method of embodiment 5, wherein generating a phase for each metacell of the metalens with IFTA at least based on the description of the incident optical signals and the target optical signals includes
when the generated phase φ satisfies φ≤b₁, translating φ to φ′=φ+2π and when

$${φ}^{′} - {a}_{N} \leq \frac{1}{2} {ε}_{p} * {g}_{N + 1} ,$$

rounding φ to a_{N} and maintaining φ unchanged otherwise.

Embodiment 8. The method of embodiment 5, wherein generating a phase for each metacell of the metalens with IFTA at least based on the description of the incident optical signals and the target optical signals includes
when the generated phase satisfies φ>b_{N+1}, translating φ to φ″=φ−2π and when

$${φ}^{″} - {a}_{N} > - \frac{1}{2} {ε}_{p} * {g}_{1} ,$$

rounding φ to a₁ and maintaining φ unchanged otherwise.

Embodiment 9. The method of embodiment 1, further comprising the step of: generating a layout information of metacells with GPU based on at least the outputted phases of all metacells of the metalens.

Embodiment 10. A metalens design system, comprising a processor and a memory communicatively coupled to the processor, wherein the processor is configured to perform a method of any one of embodiments 1-9.

Embodiment 11. A non-transitory computer readable medium storing instructions for designing a metalens that when executed by a processor cause the processor to perform a method of any one of embodiments 1-9.

What is claimed is:

1. A method for designing a metalens, comprising selecting a group of metacells from a library at least based on their corresponding phase responses;
receiving a description of incident optical signals and target optical signals;
defining a phase rounding threshold value and a maximum number of rounding operations, wherein the phase rounding threshold value varies in terms of a rounding operation number;
generating a phase for each metacell of the metalens with IFTA at least based on the description of the incident optical signals and the target optical signals;
determining if the generated phase for each metacell meets the phase rounding threshold value, and if the phase rounding threshold value is met, performing a rounding operation by rounding the generated phase to the phase of one of the metacells from the selected group; and
outputting the generated phases of all metacells when all rounding operations are completed.

2. The method of claim 1, further comprising the step of:
if at least one of the generated phases does not meet the phase rounding threshold value, continuing to generate a phase for each metacell with IFTA at least based on the result of the prior rounding operation.

3. The method of claim 1, wherein the selected group includes N metacells, and the phases of the N metacells constitute a set identified as [a₁ . . . a_{N}], wherein N is an integer no less than 2; wherein defining a phase rounding threshold value and a maximum number of rounding operation includes extending the set to [a₀ . . . a_{N+1}], wherein a₀=a_{N}−2π, a_{N+1}=a₁+2π.

4. The method of claim 3, wherein defining a phase rounding threshold value and a maximum number of rounding includes defining mid-points [b₁ . . . b_{N+1}] between adjacent points in [a₀ . . . a_{N+1}], and defining phase difference [g₁ . . . g_{N+1}] between adjacent points in [a₀ . . . a_{N+1]}.

5. The method of claim 4, wherein defining a phase rounding threshold value and a maximum number of rounding operation includes
defining the rounding operation number as integer p, and 1≤p≤N_{sq}, wherein the phase rounding threshold value series is defined as
$${\{ {ε}_{p} \}}_{p = 1}^{{N}_{sp}}$$
which varies between 0 and 1, wherein when p=1, the first phase rounding threshold value ε₁ is predetermined and 0<ε₁<½;
defining the maximum number of rounding operations as N_{sq} to be
$$ceil [ \frac{ln {ε}_{1}}{ln ( 1 - {ε}_{1} )} ] ;$$
and
defining the phase rounding threshold value as εₚ to be
$$\{ \begin{matrix}1 - {( 1 - {ε}_{1} )}^{2} , & p = 2 , \\ 1 - {( 1 - {ε}_{2} )}^{p - 1} , & 2 < p < {N}_{sq} \\ 1 , & p = {N}_{sq}\end{matrix} .$$

6. The method of claim 5, wherein generating a phase for each metacell of the metalens with IFTA at least based on the description of the incident optical signals and the target optical signals includes
when the generated phase φ satisfies b₁<φ≤b_{N+1}, specifically bⱼ<φ≤bⱼ₊₁, 1≤j≤N, when
$$- \frac{1}{2} {ε}_{p} * {g}_{j} < φ - {a}_{j} \leq \frac{1}{2} {ε}_{p} * {g}_{j + 1} ,$$
rounding φ to aⱼ, and maintaining the generated φ unchanged otherwise.

7. The method of claim 5, wherein generating a phase for each metacell of the metalens with IFTA at least based on the description of the incident optical signals and the target optical signals includes
when the generated phase φ satisfies φ≤b₁, translating φ to φ′=φ+2π and when
$${φ}^{′} - {a}_{N} \leq \frac{1}{2} {ε}_{p} * {g}_{N + 1} ,$$
rounding φ to a_{N} and maintaining φ unchanged otherwise.

8. The method of claim 5, wherein generating a phase for each metacell of the metalens with IFTA at least based on the description of the incident optical signals and the target optical signals includes
when the generated phase satisfies φ>b_{N+1}, translating φ to φ″=φ−2π and when
$${φ}^{″} - {a}_{N} > - \frac{1}{2} {ε}_{p} * {g}_{1} ,$$
rounding φ to a₁ and maintaining φ unchanged otherwise.

9. The method of claim 1, further comprising the step of: generating a layout information of metacells with GPU based on at least the outputted phases of all metacells of the metalens.

10. A metalens design system, comprising
a processor and a memory communicatively coupled to the processor, wherein the processor is configured to perform a method of claim 1.

11. A non-transitory computer readable medium storing instructions for designing a metalens that when executed by a processor cause the processor to perform a method of claim 1.
